(19) United States
(12) Patent Application Publication
(10) Pub. No.: US 2017/0265431 A1
(43) Pub. Date: Sep. 21, 2017

(54) PET GROOMING DEVICE

(71) Applicants: Charles A. Urso, Sea Ranch Lakes, FL (US); Jonathan M. Malinconico, Fort Lauderdale, FL (US)

(72) Inventors: Charles A. Urso, Sea Ranch Lakes, FL (US); Jonathan M. Malinconico, Fort Lauderdale, FL (US)

(21) Appl. No.: 15/074,427

(22) Filed: Mar. 18, 2016

(51) Int. Cl. A01K 13/00; B25G 1/10

(52) U.S. Cl. CPC A01K 13/001; A01K 13/002; B25G 1/102

(57) ABSTRACT

A pet grooming device includes a handheld housing having an ergonomically shaped top side and a bottom plate surrounding a hollow interior cavity. The bottom plate includes an arrangement of openings in air flow communication with the interior cavity and, in at least one embodiment, the bottom pate has an array of brush bristles extending therefrom. A vertical fin extends upwardly from the top side for receipt between two adjacent fingers of the user when grasping the ergonomically shaped top side. A flexible hose connects to the handheld housing and an electrically powered air flow generating device (e.g., a blow dryer) for directing air flow through the arrangement of openings on the bottom plate and onto an animal's coat.

### BACKGROUND OF THE INVENTION

### Field of the Invention

The present invention relates to pet grooming devices and, more particularly, a pet grooming device for simultaneously drying and brushing the coat of an animal.

### Discussion of the Related Art

Pet owners regularly provide grooming services for their pets, including bathing, brushing and trimming the animal's coat. Regular grooming is an important aspect of an animal's general health and well-being and, furthermore, is beneficial for controlling shedding of the pet's coat. After bathing, pets must subsequently be dried and brushed to prevent matting of the pet's coat. A significant drawback associated with bathing a pet is the time required to both dry and subsequently brush the pet's coat. While apparatuses have been made for simultaneously drying and brushing a pet's coat, these apparatuses have generally been bulky and expensive.

Accordingly, there remains a need for an affordable pet grooming device that simultaneously dries and brushes the coat of an animal, and which can be used in combination with a conventional hair dryer.

### OBJECTS AND ADVANTAGES OF THE INVENTION

Considering the foregoing, it is a primary object of the present invention to provide a pet grooming device that may be used to simultaneously dry and brush the coat of an animal.

It is a further object of the present invention to provide a pet grooming device that can be used in combination with a conventional hair dryer.

It is a further object of the present invention to provide a pet grooming device that is inexpensive to manufacture.

It is still a further object of the present invention to provide a pet grooming device that is ergonomically designed for extended use and comfort.

These and other objects and advantages of the present invention are more readily apparent with reference to the detailed description and accompanying drawings.

### SUMMARY OF THE INVENTION

The present invention is directed to a pet grooming device that includes a handheld housing connected to one end of a flexible hose, and wherein an opposite end of the flexible hose is intended to be connected to an electrically powered airflow generating device, such as an electric hair dryer so that a forced flow of air travels through the flexible hose and to the handheld housing. The handheld housing surrounds a hollow interior cavity and includes an ergonomically shaped top side, a bottom plate and a vertically extending fin on the top side for receipt between two adjacent fingers of the user when grasping the ergonomically shaped top side in the palm of the hand. The fin is structured and disposed for discouraging forward and lateral (i.e., side-to-side) movement of the user's hand relative to the handheld housing when grasping the handheld housing and using the device. A stabilizer member on a distal end of the vertical fin engages the top side of the user's two adjacent fingers when grasping the housing to help maintain the user's grasp of the handheld housing. The bottom plate of the handheld housing has openings that are sized to allow for passage of the forced airflow therethrough. In a preferred embodiment, the flexible hose is connected to the output nozzle or barrel of a conventional handheld electric hair dryer so that the warm air generated by the hair dryer travels through the hose and out from the openings on the bottom plate of the handheld housing. In operation, the electric hair dryer (i.e., blow dryer) is activated to direct the flow of warm air through the hose and out from the openings of the housing, and the flow of air is directed against the animal's coat as the user moves the bottom plate of the handheld housing over the animal's coat.

### BRIEF DESCRIPTION OF THE DRAWINGS

For a fuller understanding of the nature of the present invention, reference should be made to the following detailed description taken in conjunction with the accompanying drawings in which:

FIG. 1 is a perspective view illustrating the handheld housing and a section of the flexible hose of the pet grooming device of the present invention;

FIG. 2 is a side elevational view showing use of the pet grooming device for simultaneously drying and brushing a dog's coat while the user grasps the handheld housing of the device and moves the bristles on the bottom plate of the handheld housing over the dog's coat;

FIG. 3 is an isolated cross-sectional view of the handheld housing of the pet grooming device of the present invention, and wherein a flow of air is shown entering through the openings of the bottom plate of the handheld housing and into the flexible hose in the instance that the opposite end of the flexible hose is connected to a vacuum device to remove hair, dirt and debris from an animal's coat;

FIG. 4A is a bottom perspective view of the handheld housing of the pet grooming device in accordance with one embodiment of the invention, wherein bristles extend from the bottom plate of the handheld device for use to brush an animal's coat;

FIG. 4B is a bottom perspective view of another embodiment of the handheld housing of the pet grooming device of the present invention, wherein the bottom plate of the handheld housing is generally flat with air openings formed therein, allowing use of the device for drying animal's coat without contacting or brushing the animal;

FIG. 5 is a perspective view showing a user's hand properly grasping the ergonomically shaped top side of the handheld housing of the pet grooming device of the present invention, and wherein the opposite end of the flexible hose in connected to the air discharge opening on the barrel of a conventional electrical hair blow dryer device; and

FIG. 6 is an isolated cross-sectional view of the handheld housing of the pet grooming device of the present invention, and wherein the handheld housing is shown brushing an animal's coat with a forced flow of air from the electric hair dryer and directed out through the openings in the bottom plate of the handheld housing and onto the animal's coat for drying the animal's coat while simultaneously brushing the coat.

Like reference numerals refer to like parts throughout the several views of the drawings.

### DETAILED DESCRIPTION OF THE PREFERRED EMBODIMENTS

Throughout the several views of the drawings, the pet grooming device of the present invention is shown and is generally indicated as 10.

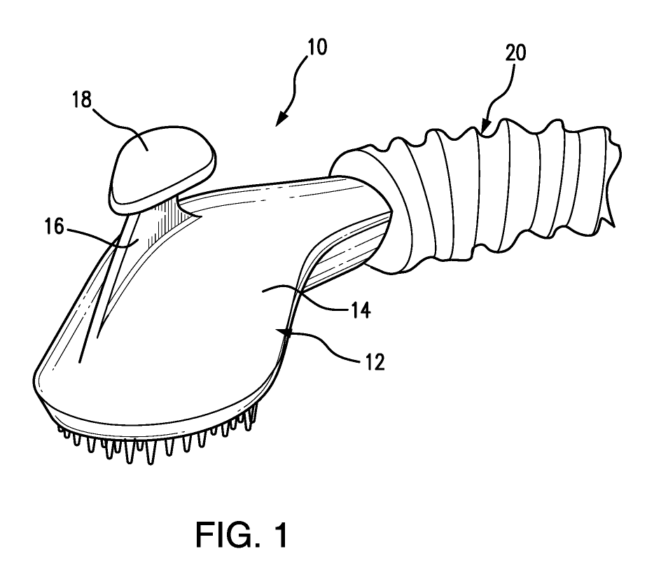

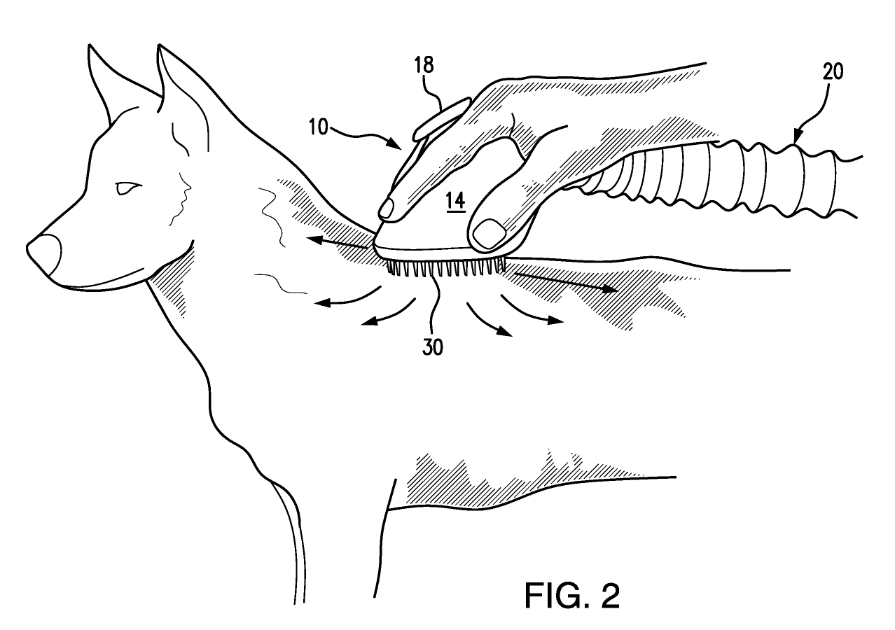

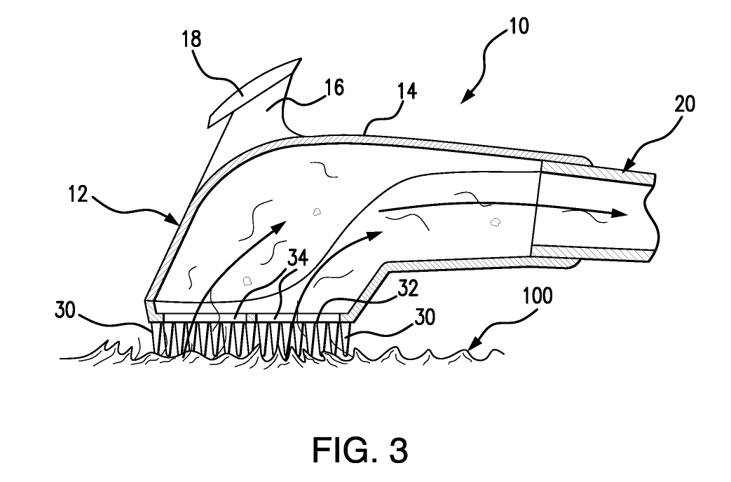

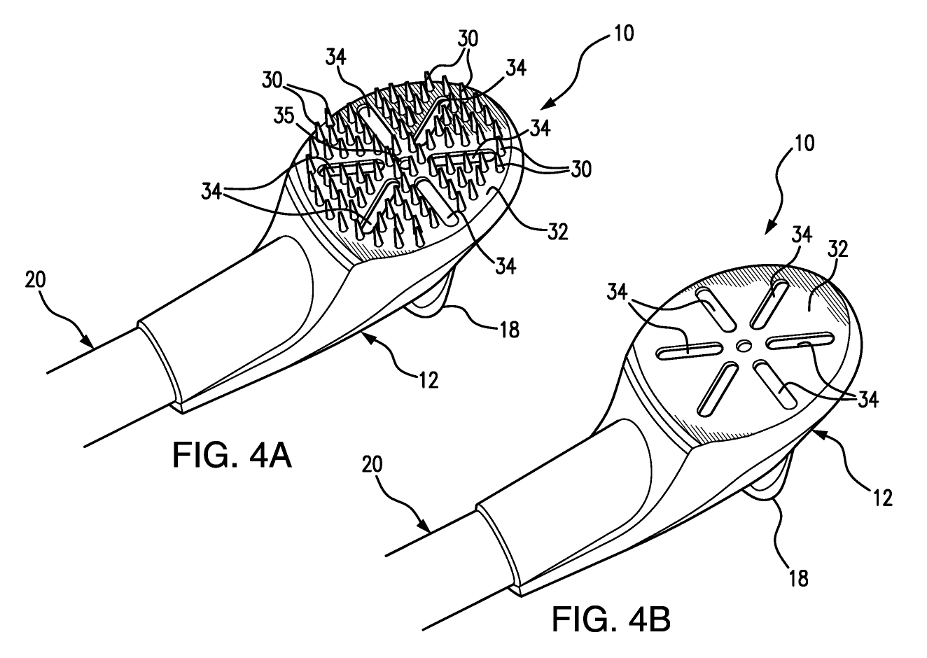

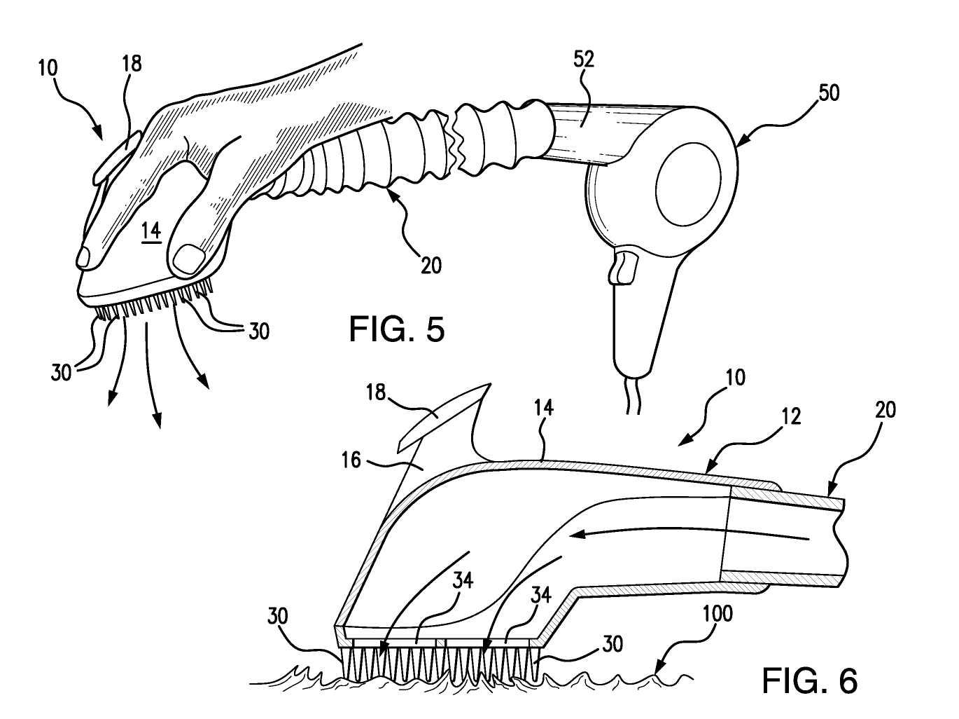

Referring initially to FIGS. 1 and 4A, the grooming device 10 of the present invention includes a handheld housing 12 having an ergonomically shaped top side 14 and a vertically extending fin 16 extending up from the top side 14. A stabilizing member 18 is provided on the distal top end of the fin 16. The ergonomically shaped top surface 14 is specifically sized, shaped and configured for comfortable, ergonomic grasp within the user's hand, as seen in FIGS. 2 and 5 so that the fin 16 is received between two adjacently positioned fingers, such as the index finger and middle finger, or between the middle finger and ring finger. When positioned between the two adjacent fingers, the fin 16 discourages forward and lateral movement of the user's hand relative to the handheld housing 12. The stabilizing member 18 is generally perpendicular to the vertical sides of the fin 16 and is oriented downwardly towards the front end of the handheld housing, as best seen in FIGS. 3 and 6. This provides a space between a bottom surface of the stabilizing member 18 and the top ergonomic side 14 of the handheld housing 12 to allow the user's fingers to extend over the downwardly curving front portion of the handheld housing while the stabilizing member 18 engages the top of the adjacent fingers, positioned on opposite sides of the fin 16, to thereby promote a secure grasp of the handheld housing 12 within the user's hand, while discouraging slipping or separation of the user's hand from the grasp on the top ergonomic surface 14 during use of the device, as seen in FIG. 2. The downward curvature of the front portion allows for a natural, ergonomic grip with the fingers to discourage backward slipping of the user's hand on the top side when grasping and using the device.

Referring to FIGS. 3 and 4A, the handheld housing 12 further includes a bottom plate 32 having an arrangement of air flow openings 34 formed therethrough and in air flow communication with a hollow interior of the handheld housing. A back end of the handheld housing, at the rear neck portion, is open. A flexible hose 20 connects to the back end of the housing 12 in air flow communication with the open back end and the hollow interior. The opposite end of the flexible hose 20 is intended to be connected to an electrically powered airflow generating device, such as a handheld electric hair dryer (i.e., blow dryer) 50, as seen in FIG. 5. More particularly, the opposite end of the flexible hose 20 connects to the airflow output of the airflow generating device, such as on the end of the nozzle or barrel 52 of the electric hair dryer 50, so that warm airflow is directed through the flexible hose, into the hollow interior of the handheld housing 12 and out through the openings 34 of the bottom plate 32 (see FIG. 6).

Referring to FIG. 4B, one embodiment of the handheld housing 12 has a flat bottom plate 32 with the arrangement of airflow openings 34 formed therethrough. In this particular embodiment, the handheld housing is not intended to directly contact an animal's coat but, instead, is moved over the animal's coat at a spaced distance so that the forced warm airflow generated by the electric device, such as the hair dryer 50, is directed out through the openings 34 and onto the animal's coat for drying the coat (e.g., after bathing).

Referring to FIG. 4A and the remaining drawing figures, another embodiment of the handheld housing 12 includes brush bristles 30 extending downwardly from the bottom plate 32 with the arrangement of airflow openings 34 positioned between sections of the brush bristles 30. This particular embodiment of the invention, as shown in FIGS. 1-4A and 5-6, allows the handheld housing to be moved over the animal's coat, as the brush bristles are moved through the coat to brush the animal, while simultaneously directing warm air flow from the connected hair dryer 50 out through the air flow openings 34 and against the animal's coat for drying the coat. Thus, the pet grooming device 10 can be used to simultaneously brush an animal's coat and dry the animal's coat after bathing, or in any instance wherein the animal's coat has been soaked (e.g., such as from swimming or being in the rain).

While the present invention has been shown and described in accordance with several preferred and practical embodiments, it is recognized that departures from the instant disclosure are fully contemplated within the spirit and scope of the present invention which are not to be limited, except as defined in the following claims, as interpreted under the Doctrine of Equivalents.

What is claimed is:

1. A grooming device for use in combination with an electrically powered air flow generating device, said grooming device comprising:
a handheld housing having an ergonomically shaped top side and a bottom plate surrounding a hollow interior, and a vertically extending fin extending upwardly from the top side and having a stabilizing member on a top distal end, the stabilizing member being oriented generally perpendicularly to the fin, and the fin being structured and disposed for receipt between two adjacent fingers of a user while grasping the ergonomically shaped top side with the stabilizing member engaging a top of the adjacently positioned fingers for promoting a secure grasp of the handheld housing within the user's hand, while discouraging slipping and separation of the user's hand from the grasp of the top side of the handheld housing, and a plurality of airflow openings formed through the bottom plate for allowing airflow between the hollow interior of the handheld housing and an exterior of the housing; and
a flexible hose having a first end connected in airflow communication with the hollow interior of the handheld housing, and an opposite second end of the flexible hose being structured and disposed for connection to the electrically powered airflow generating device so that airflow generated by the airflow generating device is directed through the flexible hose, the hollow interior of the handheld housing and the plurality of airflow openings formed in the bottom plate.

2. The grooming device as recited in claim 1 further comprising:
a plurality of brush bristles extending downwardly from the bottom plate of the handheld housing.

3. The grooming device as recited in claim 2 wherein the plurality of brush bristles are arranged in sections between the plurality of air flow openings.

4. The grooming device as recited in claim 1 wherein the ergonomically shaped top side further includes a downwardly sloped forward portion for engagement with the user's fingers while grasping the ergonomically shaped top side to promote a secure grip of the handheld housing and to discourage movement of the user's hand relative to the handheld housing while grasping and using the grooming device.

5. A grooming device for use in combination with an electrically powered air flow generating device, the grooming device comprising:
a handheld housing having a top side that is structured and configured for ergonomic receipt within the grasp of a user's hand, a bottom side including a bottom plate, a front end and a back end, and the top side and the bottom side surrounding a hollow interior chamber, and the bottom plate having a plurality of openings formed therethrough in air flow communication with the hollow interior chamber;
a fin extending vertically upward from the top side of the handheld housing and being structured and disposed for receipt between two adjacent fingers of the user when grasping the top side within the user's hand, wherein the fin discourages forward and lateral movement of the user's hand relative to the handheld housing when grasping the top side and using the grooming device; and
a flexible hose having a first end connected in air flow communication with the hollow interior of the handheld housing, and an opposite second end structured and disposed for connection to the electrically powered air flow generating device so that airflow generated by the air flow generating device is directed through the flexible hose, the hollow interior of the handheld housing and the plurality of openings formed in the bottom plate.

6. The grooming device as recited in claim 5 further comprising:
a plurality of brush bristles extending downwardly from the bottom plate of the handheld housing.

7. The grooming device as recited in claim 5 wherein the plurality of brush bristles are arranged in sections between the plurality of openings formed in the bottom plate.

8. The grooming device as recited in claim 5 wherein the ergonomically shaped top side further includes a downwardly sloped forward portion for engagement with the user's fingers while grasping the ergonomically shaped top side to promote a secure grip of the handheld housing and to discourage movement of the user's hand relative to the handheld housing while grasping and using the grooming device.

9. The grooming device as recited in claim 5 further comprising:
a stabilizing member on a top distal end of the fin, the stabilizing member being oriented generally perpendicular to the fin and being structured and disposed for engaging a top of the two adjacent fingers of the user with the fin positioned between the two adjacent fingers of the user, and the stabilizing member being structured and disposed for discouraging slipping and separation of the user's hand from the grasp of the top side of the handheld housing when grasping the top side and using the grooming device.
